(19) United States
(12) Patent Application Publication
(10) Pub. No.: US 2011/0210069 A1
(43) Pub. Date: Sep. 1, 2011

(54) WATER TREATMENT DEVICE AND METHOD

(76) Inventors: Rihua Xiong, Shanghai (CN); Wei Cai, Shanghai (CN); Andrew Jon Zaske, Chanhassen, MN (US)

(21) Appl. No.: 12/850,475

(22) Filed: Aug. 4, 2010

(30) Foreign Application Priority Data
Feb. 26, 2010 (CN) 201010116804.X

(51) Int. Cl. C02F 1/469

(52) U.S. Cl. 210/638; 210/202

(57) ABSTRACT

A water treatment device comprises: a membrane desalination unit; a first conduit transporting a first stream of feed water to the membrane unit; a second conduit transporting a first stream of product water from the membrane desalination unit; an electrical separation unit; a third conduit transporting a first stream of reject water from the membrane desalination unit to the electrical separation unit; a fourth conduit transporting a second stream of product water from the electrical separation unit; a precipitation unit; a fifth conduit transporting a second stream of reject water from the electrical separation unit to the precipitation unit; a sixth conduit transporting a second stream of feed water from the precipitation unit to the electrical separation device; a seventh conduit releasing a discharge stream of water; and a chemical injection unit communicating with at least one of the electrical separation device and the precipitation unit. Associated method is provided.

### CROSS-REFERENCE TO RELATED APPLICATIONS

This application claims priority under 35 U.S.C. §119(a)-(d) or (f) to prior-filed, co-pending Chinese patent application serial number 201010116804.X, filed on Feb. 26, 2010, which is hereby incorporated by reference in its entirety.

### BACKGROUND OF THE INVENTION

1. Field of Invention

The invention relates generally to liquid treatment devices and methods. More particularly, this invention relates to water treatment devices and methods.

2. Description of the Prior Art

Membrane desalination devices, for example, nanofiltration membrane devices or reverse osmosis membrane devices are used in beverage plants to yield product water because of their reliabilities in qualities of product water. However, the membrane desalination devices have problems of scaling tendencies on their membranes, so the product water recovery rate of a typical membrane desalination device is in the range of from about 50% to about 90%. The rest 10˜50% of feed water is usually discharged as wastewater. Beverage plants in the world consume a large amount of usable water everyday, thereby needing a huge amount of source water to be treated by the membrane desalination devices and discharging a large amount of wastewater, which leads to high costs and high waste and is undesirable.

In addition, people and almost every industry in the whole world also need more and more usable water and can not afford discharging more wastewater.

Therefore, there is a need to develop a new water treatment device and method.

### SUMMARY OF THE INVENTION

In one aspect, a water treatment device is provided, comprising: a membrane desalination unit; a first conduit connected with the membrane desalination unit and configured to transport a first stream of feed water to the membrane desalination unit; a second conduit connected with the membrane desalination unit and configured to transport a first stream of product water of lower salinity than the first stream of feed water out of the membrane desalination unit; an electrical separation unit; a third conduit connected with the membrane desalination unit and the electrical separation unit and configured to transport a first stream of reject water of higher salinity than the first stream of feed water from the membrane desalination unit to the electrical separation unit; a fourth conduit connected with the electrical separation unit and configured to transport a second stream of product water of lower salinity than the first stream of reject water out from the electrical separation unit; a precipitation unit; a fifth conduit connected with the precipitation unit and the electrical separation unit and configured to transport a second stream of reject water of higher salinity than the first stream of reject water from the electrical separation unit to the precipitation unit; a sixth conduit connected with the precipitation unit and the electrical separation unit and configured to transport a second stream of feed water of lower salinity than the second stream of reject water from the precipitation unit to the electrical separation unit; a seventh conduit connected with the precipitation unit and configured to release a discharge stream of water; and a chemical injection unit in communication with at least one of the electrical separation unit and the precipitation unit.

In another aspect, a method is provided. The method comprises: providing a membrane desalination unit; providing a first conduit connected with the membrane desalination unit and configured to transport a first stream of feed water to the membrane desalination unit; providing a second conduit connected with the membrane desalination unit and configured to transport a first stream of product water of lower salinity than the first stream of feed water out of the membrane desalination unit; providing an electrical separation unit; providing a third conduit connected with the membrane desalination unit and the electrical separation unit and configured to transport a first stream of reject water of higher salinity than the first stream of feed water from the membrane desalination unit to the electrical separation unit; providing a fourth conduit connected with the electrical separation unit and configured to transport a second stream of product water of lower salinity than the first stream of reject water out from the electrical separation unit; providing a precipitation unit; providing a fifth conduit connected with the precipitation unit and the electrical separation unit and configured to transport a second stream of reject water of higher salinity than the first stream of reject water from the electrical separation unit to the precipitation unit; providing a sixth conduit connected with the precipitation unit and the electrical separation unit and configured to transport a second stream of feed water of lower salinity than the second stream of reject water from the precipitation unit to the electrical separation unit; providing a seventh conduit connected with the precipitation unit and configured to release a discharge stream of water; and providing a chemical injection unit in communication with at least one of the electrical separation unit and the precipitation unit.

These and other advantages and features will be better understood from the following detailed description of preferred embodiments of the invention that is provided in connection with the accompanying drawings.

### BRIEF DESCRIPTION OF THE DRAWINGS

FIG. 1 is a schematic diagram of a water treatment device in accordance with one embodiment of the invention; and

FIG. 2 is a schematic diagram of part of a water treatment device comprising an electrodialysis reversal (EDR) unit and a precipitation unit used in the experimental example.

### DETAILED DESCRIPTION OF THE INVENTION

Preferred embodiments of the present disclosure will be described hereinbelow with reference to the accompanying drawings. In the following description, well-known functions or constructions are not described in detail to avoid obscuring the disclosure in unnecessary detail.

Approximating language, as used herein throughout the specification and claims, may be applied to modify any quantitative representation that could permissibly vary without resulting in a change in the basic function to which it is related. Accordingly, a value modified by a term or terms, such as “about” or “substantially”, is not to be limited to the precise value specified. In some instances, the approximating language may correspond to the precision of an instrument for measuring the value. Moreover, the suffix “(s)” as used herein is usually intended to include both the singular and the plural of the term that it modifies, thereby including one or more of that term.

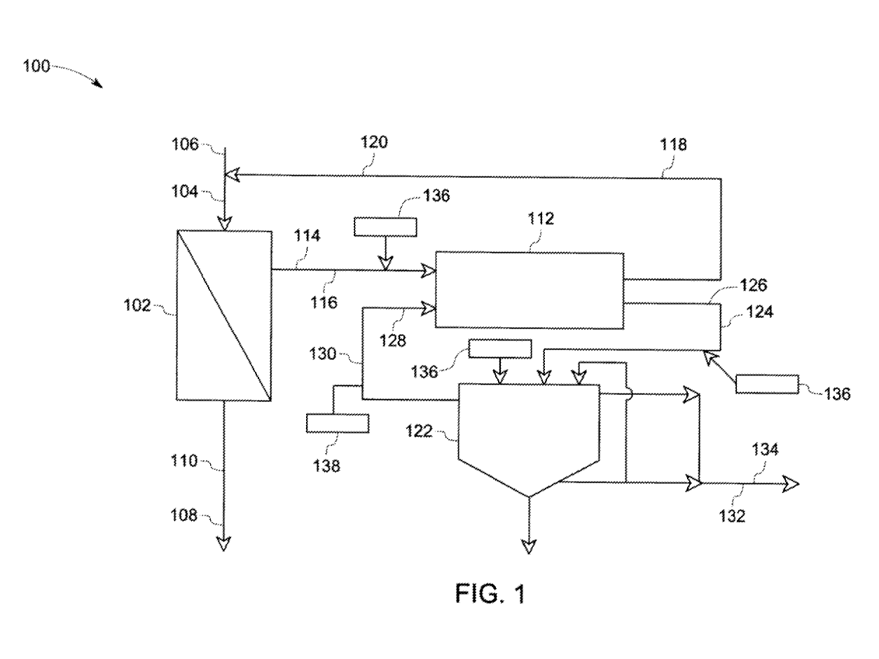

FIG. 1 is a schematic diagram of a water treatment device 100 in accordance with one embodiment of the present invention. The water treatment device 100 comprises: a membrane desalination unit 102; a first conduit 104 connected with the membrane desalination unit and configured to transport a first stream of feed water 106 to the membrane desalination unit; a second conduit 108 connected with the membrane desalination unit and configured to transport a first stream of product water 110 of lower salinity than the first stream of feed water out of the membrane desalination unit; an electrical separation unit 112; a third conduit 114 connected with the membrane desalination unit and the electrical separation unit and configured to transport a first stream of reject water 116 of higher salinity than the first stream of feed water from the membrane desalination unit to the electrical separation unit; a fourth conduit 118 connected with the electrical separation unit and configured to transport a second stream of product water 120 of lower salinity than the first stream of reject water out from the electrical separation unit; a precipitation unit 122; a fifth conduit 124 connected with the precipitation unit and the electrical separation unit and configured to transport a second stream of reject water 126 of higher salinity than the first stream of reject water from the electrical separation unit to the precipitation unit; a sixth conduit 128 connected with the precipitation unit and the electrical separation unit and configured to transport a second stream of feed water 130 of lower salinity than the second stream of reject water from the precipitation unit to the electrical separation unit; a seventh conduit 132 connected with the precipitation unit and configured to release a discharge stream of water 134; and a chemical injection unit 136 in communication with at least one of the electrical separation unit and the precipitation unit.

In the illustrated embodiment, the fourth conduit 118 is connected with the first conduit 104 and configured to transport the second stream of product water 120 to mix with the first stream of feed water 106. The membrane desalination unit 102 may comprise a nanofiltration membrane device, a reverse osmosis membrane device or a combination thereof. The product water recovery rate of a typical membrane desalination device is in the range of from about 50% to about 90%. The electrical separation unit 112 may comprise an electrodialysis reversal (EDR) desalination device, a supercapacitive desalination (SCD) device, or a combination thereof. The water recovery of an EDR or SCD plus precipitation unit is typically in the range of from about 80% to about 99%. Therefore, the overall water recovery of the water treatment device 100 is in the range of from about 90% to about 99.9% and a volumetric flow rate of the first stream of product water 110 is in the range of from about 90% to about 99.9% of a volumetric flow rate of the first stream of feed water 106. For applications like beverage plants which need water of high quality, the water treatment device 100 yields much usable product water and discharge little wastewater.

In some embodiments, the fourth conduit 118 may be not connected with the first conduit 104 and configured to transport the second stream of product water 120 into another water treatment device (not shown) or directly out. In such way, product water of the water treatment device 100 are in two separate streams 110, 120. The total water recovery rate is still high.

In some instances, some dissolved alkalies, such as bicarbonates, will turn into unsolvable or barely solvable salts, e.g., calcium carbonate (CaCO₃) to build up/scale in the electrical separation unit because of the high concentration of water that is handled by the electrical separation unit and the precipitation unit. In some embodiments, the chemical injection unit 136 comprises an acid injection unit providing hydrochloric acid or sulfuric acid to reduce alkalinity by reacting hydrochloric acid or sulfuric acid with bicarbonates.

The chemical injection unit 136 may be in communication with the electrical separation unit and/or the precipitation unit directly, or through the third conduit 114 and/or the fifth conduit 124.

In the illustrated example, the water treatment device 100 comprises a filtration device 138 in communication with the sixth conduit 128 to prevent particles (not shown, if any) from entering into the electrical separation unit 112. The filtration device 138 may comprise a cartridge filter.

In another aspect, a method is provided. The method comprises: providing a membrane desalination unit 102; providing a first conduit 104 connected with the membrane desalination unit and configured to transport a first stream of feed water 106 to the membrane desalination unit; providing a second conduit 108 connected with the membrane desalination unit and configured to transport a first stream of product water 110 of lower salinity than the first stream of feed water out of the membrane desalination unit; providing an electrical separation unit 112; providing a third conduit 114 connected with the membrane desalination unit and the electrical separation unit and configured to transport a first stream of reject water 116 of higher salinity than the first stream of feed water from the membrane desalination unit to the electrical separation unit; providing a fourth conduit 118 connected with the electrical separation unit and configured to transport a second stream of product water 120 of lower salinity than the first stream of reject water out from the electrical separation unit; providing a precipitation unit 122; providing a fifth conduit 124 connected with the precipitation unit and the electrical separation unit and configured to transport a second stream of reject water 126 of higher salinity than the first stream of reject water from the electrical separation unit to the precipitation unit; providing a sixth conduit 128 connected with the precipitation unit and the electrical separation unit and configured to transport a second stream of feed water 130 of lower salinity than the second stream of reject water from the precipitation unit to the electrical separation unit; providing a seventh conduit 132 connected with the precipitation unit and configured to release a discharge stream of water 134; and providing a chemical injection unit 136 in communication with at least one of the electrical separation unit and the precipitation unit.

For certain arrangements, the electrical separation unit may be an SCD device. The term “SCD device” may generally indicate supercapacitors that are employed for desalination of seawater or deionization of other brackish waters to reduce the amount of salt or other ionized impurities to a permissible level for domestic and industrial use. In certain applications, the supercapacitor desalination device may comprise one or more supercapacitor desalination cells (not shown). As is known, in non-limiting examples, each supercapacitor desalination cell may at least comprise a pair of electrodes, a spacer, and a pair of current collectors attached to the respective electrodes. A plurality of insulating separators may be disposed between each pair of adjacent SCD cells when more than one supercapacitor desalination cell stacked together is employed.

In embodiments of the invention, the current collectors may be connected to positive and negative terminals of a power source (not shown), respectively. Since the electrodes are in contact with the respective current collectors, the electrodes may act as anodes and cathodes, respectively.

During the charging state of the supercapacitor desalination device 112, an input stream 116 from the membrane desalination device 102 passes through a valve (not shown) and enters into the SCD device for desalination. In this state, the flow path of an input stream 130 to the SCD device 112 is closed by valve (not shown). Positive and negative electrical charges from the power source accumulate on surfaces of the anode(s) and the cathode(s), respectively and attract anions and cations from the ionized input stream 116, which causes them to be adsorbed on the surfaces of the anode(s) and the cathode(s), respectively. As a result of the charge accumulation on the anode(s) and the cathode(s), an outflow stream, such as an output stream 120 from the SCD device 112 passing through valve (not shown) may have a lower salinity (concentration of salts or other ionic impurities) as compared to the input stream 116

In the discharging state of the supercapacitor desalination device 112, the adsorbed anions and cations dissociate from the surfaces of the anode(s) and the cathode(s), respectively. The input stream 130 is pumped by pump (not shown) from the precipitation unit 122, and passes through filter (not shown) and valve (not shown) to enter the SCD device 112 to carry ions (anions and cations) therefrom. An outflow stream 126 flowing from the SCD device 112 and passing through the valve (not shown) has a higher salinity (concentration of the salt or other ionic impurities) as compared with the input stream 130. In this state, the flow path of the input stream 116 to the SCD device 112 is closed by the valve (not shown). In certain applications, filter may not be provided.

After discharging of the SCD device is complete, the SCD device is placed in the charging state for a period of time for preparation of a subsequent discharging. That is, the charging and the discharging of the SCD device are alternated for treating input streams 116 and 130, respectively.

As the water is circulated through the SCD unit and the precipitation unit in the discharging state, the concentration of salts or other ionic impurities in the water increases so as to produce precipitate in the precipitation unit 122. The precipitate particles (solids) with diameters larger than a specified diameter may settle by gravity in the lower portion of the precipitation unit 122. Other precipitate particles with diameters smaller than the specified diameter may be dispersed in the water.

When the precipitation rate plus a blow down rate of stream 134 equals the charged species removal rate from the input stream 116, where the rates are averaged over one or more charging-discharging cycles, the degree of saturation or supersaturation of the streams circulating between the SCD unit and the precipitation unit may stabilize and a dynamic equilibrium may be established.

In certain examples, the energy released in the discharging state may be used to drive an electrical device (not shown), such as a light bulb, or may be recovered using an energy recovery cell, such as a bi-directional DC-DC converter.

In other non-limiting examples, similar to the SCD cells stacked together, the supercapacitor desalination device may comprise a pair of electrodes, a pair of current collectors attached to the respective electrodes, one or more bipolar electrodes disposed between the pair of electrodes, and a plurality of spacers disposed between each of the pairs of adjacent electrodes for processing first stream of reject water 116 in a charging state and second stream of feed water 130 in a discharging state. Each bipolar electrode has a positive side and a negative side, separated by an ion-impermeable layer.

In some embodiments, the current collectors may be configured as a plate, a mesh, a foil, or a sheet and formed from a metal or metal alloy. The metal may include titanium, platinum, iridium, or rhodium, for example. The metal alloys may include stainless steel, for example. In other embodiments, the current collectors may comprise graphite or plastic material, such as polyolefin, which may include polyethylene. In certain applications, the plastic current collectors may be mixed with conductive carbon blacks or metallic particles to achieve a certain level of conductivity.

The electrodes and/or bipolar electrodes may include electrically conductive materials, which may or may not be thermally conductive, and may have particles with small sizes and large surface areas. In some examples, the electrically conductive material may include one or more carbon materials. Non-limiting examples of the carbon materials include activated carbon particles, porous carbon particles, carbon fibers, carbon aerogels, porous mesocarbon microbeads, or combinations thereof. In other examples, the electrically conductive materials may include a conductive composite, such as oxides of manganese, or iron, or both, or carbides of titanium, zirconium, vanadium, tungsten, or combinations thereof.

Additionally, the spacer may comprise any ion-permeable, electronically nonconductive material, including membranes and porous and nonporous materials to separate the pair of electrodes. In non-limiting examples, the spacer may have or itself may be space to form flow channels through which a liquid for processing passes between the pair of electrodes.

In certain examples, the electrodes, the current collectors, and/or the bipolar electrodes may be in the form of plates that are disposed parallel to each other to form a stacked structure. In other examples, the electrodes, the current collectors, and/or the bipolar electrodes may have varied shapes, such as a sheet, a block, or a cylinder. Further, the electrodes, the current collectors, and/or the bipolar electrodes may be arranged in varying configurations. For example, the electrodes, the current collectors, and/or the bipolar electrodes may be disposed concentrically with a spiral and continuous space therebetween.

For certain arrangements, the electrical separation unit may be an electrodialysis reversal (EDR) device. The term “EDR” may indicate an electrochemical separation process using ion exchange membranes to remove ions or charged species from water and other fluids.

As is known, in some non-limiting examples, the EDR device comprises a pair of electrodes configured to act as an anode and a cathode, respectively. A plurality of alternating anion- and cation-permeable membranes are disposed between the anode and the cathode to form a plurality of alternating dilute and concentrate channels therebetween. The anion-permeable membrane(s) are configured to be passable for anions. The cation-permeable membrane(s) are configured to be passable for cations. Additionally, the EDR device may further comprise a plurality of spacers disposed between each pair of the membranes, and between the electrodes and the adjacent membranes.

Accordingly, while an electrical current is applied to the EDR device 112, water, such as the streams 116 and 130 (as shown in FIG. 1) pass through the respective alternating dilute and concentrate channels, respectively. In the dilute channels, the first stream 116 is ionized. Cations in the first stream 116 migrate through the cation-permeable membranes towards the cathode to enter into the adjacent channels. The anions migrate through the anion-permeable membranes towards the anode to enter into other adjacent channels. In the adjacent channels (concentrate channels) located on each side of a dilute channel, the cations may not migrate through the anion-permeable membranes, and the anions may not migrate through the cation permeable membranes, even though the electrical field exerts a force on the ions toward the respective electrode (e.g. anions are pulled toward the anode). Therefore, the anions and cations remain in and are concentrated in the concentrate channels.

As a result, the second stream of feed water 130 passes through the concentrate channels to carry the concentrated anions and cations out of the EDR unit 112 so that the outflow stream 126 may be have a higher salinity than the input stream 130. After the circulation of the liquid in the EDR unit 112, the precipitation of the salts or other impurities may occur in the precipitation unit 122.

In some examples, the polarities of the electrodes of the EDR device 112 may be reversed, for example, every 15-50 minutes so as to reduce the fouling tendency of the anions and cations in the concentrate channels. Thus, in the reversed polarity state, the dilute channels from the normal polarity state may act as the concentrate channels for the second stream 130, and the concentrate channels from the normal polarity state may function as the dilution channels for the input stream 116.

In some EDR applications, the electrodes may include electrically conductive materials, which may or may not be thermally conductive, and may have particles with small sizes and large surface areas. The spacers may comprise any ion-permeable, electronically nonconductive material, including membranes and porous and nonporous materials. In non-limiting examples, the anion permeable membrane may comprise a quaternary amine group. The cation permeable membrane may comprise a sulfonic acid group or a carboxylic acid group.

In some embodiments, the precipitation of the salts or other impurities may not occur very quickly until the degree of saturation or supersaturation thereof is very high. For example, calcium sulfate (CaSO₄) often reaches a degree of supersaturation of about 400% before precipitation occurs in about 5 minutes, which may be disadvantageous to the precipitation system. Accordingly, in certain examples, seed particles (not shown) may be added into the precipitation unit to induce quick precipitation on surfaces thereof at a lower degree of supersaturation of the salts or other ionic impurities. Additionally, agitation devices and/or pumps may be provided to facilitate suspension of the seed particles in the precipitation unit.

In non-limiting examples, the seed particles may have an average diameter range from about 1 to about 500 microns, and may have a concentration range of from about 0.1 weight percent (wt %) to about 30 wt % of the weight of the water in a precipitation zone of the precipitation unit. In some examples, the seed particles may have an average diameter range from about 5 to about 100 microns, and may have a concentration range of from about 0.1 wt % to about 20 wt % of the weight of the liquid in the precipitation zone. In certain applications, the seed particles may comprise solid particles including, but not limited to CaSO₄ particles and their hydrates to induce the precipitation. The CaSO₄ particles may have an average diameter range from about 10 microns to about 200 microns. In some examples, the CaSO₄ seed particle concentration may be in a range of from about 0.1 wt % to about 2.0 wt % of the weight of the liquid in the precipitation zone, so that the concentration of CaSO₄ in the solution leaving the precipitation unit 122 may be controlled in a range of from about 100% to about 150% of saturation.

It should be noted that seed particles are not limited to any particular seed particles, and may be selected based on specific applications.

### Example

The following example is included to provide additional guidance to those of ordinary skill in the art in practicing the claimed invention. Accordingly, this example does not limit the invention as defined in the appended claims.

Experiments using nano-filtration (NF) membranes or reverse osmosis (RO) membranes were not conducted and major ion species and total dissolved solids (TDS) in feed stream, product stream and reject stream of an industrial NE unit are shown in Table 1 below as an example. There are no or nearly zero suspended solids in the feed, product and reject streams of the industrial NE membrane device.

TABLE 1

| | Composition (ppm wt/wt) | | | | | | | |
|---|---|---|---|---|---|---|---|---|
| | Ca²⁺ | Mg²⁺ | Na⁺ | K⁺ | HCO³⁻ | SO₄²⁻ | Cl⁻ | TDS |
| Feed Stream | 27 | 25 | 70 | 3.2 | 183 | 105 | 54 | 467 |
| Product Stream | 0.8 | 0.9 | 23 | 0.7 | 17.1 | 1.1 | 23 | 67 |
| Reject Stream | 171 | 162 | 445 | 23 | 898 | 843 | 338 | 2880 |

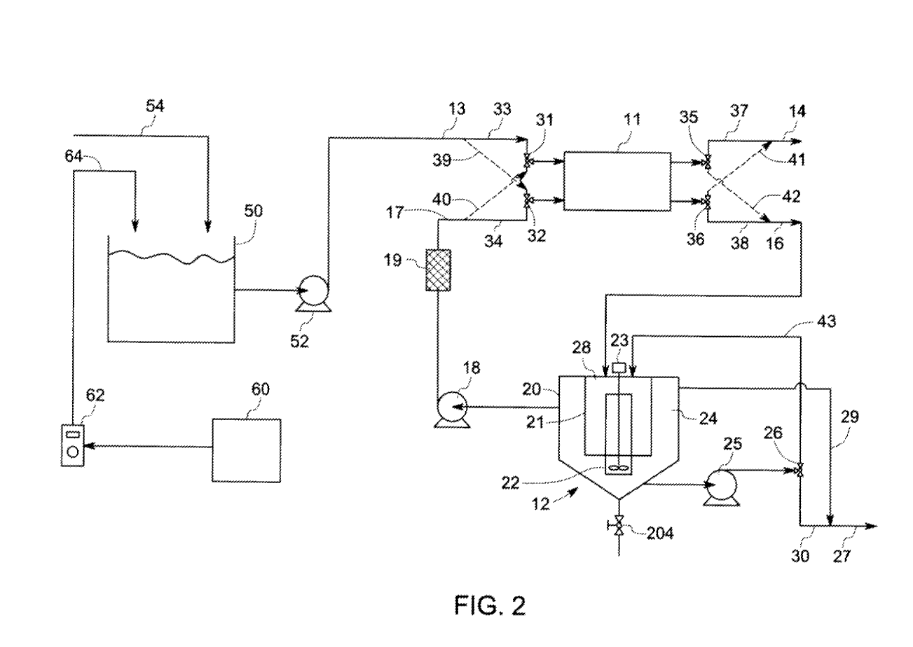

FIG. 2 shows a schematic diagram of part of a water treatment device comprising an electrodialysis reversal (EDR) unit 11 and a precipitation unit 12 and used in the experimental example.

Water was made in the lab to have the same composition as that of the reject stream of table 1 to simulate as an NF reject stream 54. The NF reject stream 54 was fed into a feed tank 50 and mixed with an acid injection stream 64 to be at least partially neutralized in alkalinity thereof. The acid injection stream 64 was pumped through an acid injection pump 62 from an acid tank (acid injection unit) 60. The acid injection stream 64 comprised hydrochloric acid (about 37% concentration by weight) which reacted with alkalinity as shown in the following formula: HCl+HCO₃⁻→H₂O+CO₂+Cl⁻. The resulted carbon dioxide gas was released from the feed tank 50. Agitation device (not shown) was used in the feed tank to enhance the mixing and the reaction. Gas sparing device or other de-gassing device (not shown) may be also used in the feed tank or in a separate location to enhance the removal of carbon dioxide gas from the water. Acid additives that may be added into the feed tank 50 include but are not limited to hydrochloric acid and sulfuric acid.

After the alkalinity reduction in the feed tank 50, the water stream 13 was pumped into the dilute channels of the EDR unit 11 through the feed pump 52 under the guidance of flow reversal valve 31 along first input pipes, as indicated by solid line 33. At the same time, a concentrate stream 17 from a solid-liquid separation zone 24 of the precipitation unit 12 was introduced into the concentrate channels of the EDR unit 11 through the concentrate recirculation pump 18 under the guidance of flow reversal valve 32 along first input pipe, as indicated by solid line 34. A cartridge filter 19 was used between the concentrate recirculation pump 18 and the EDR unit 11 to prevent particles from entering into the EDR unit 11.

While an electrical current is applied to the EDR unit 11 through a power supply (not shown), cations in the dilute channels migrate through the cation exchange membranes towards the cathode to enter into the adjacent concentrate channels. Anions migrate through the anion exchange membranes towards the anode to enter into other adjacent concentrate channels. In the adjacent concentrate channels located on each side of a dilute channel, cations may not migrate through the anion-permeable membranes, and the anions may not migrate through the cation exchange membranes, even though the electrical field exerts a force on the ions toward the respective electrode (e.g. anions are pulled toward the anode). Therefore, the anions and cations remain in and are concentrated in the concentrate channels.

As a result, the feed stream 13 passed through the dilute channels of the EDR unit 11 was partially desalinated so that the corresponding outflow stream 14 had a lower salinity than the input stream 13. The concentrate stream 17 passed through the concentrate channels to carry the concentrated anions and cations out of the EDR device 11 so that the corresponding outflow stream 16 had a higher salinity than the input stream 17. The product stream 14 and the output brine stream 16 flowed out through the control of the flow reversal valves 35 and 36, respectively and enter into respective first output pipes, as indicated by solid lines 37 and 38. The brine stream 16 was fed into a precipitation zone 28 of the precipitation unit 12.

In order to reduce the scaling tendency of the anion exchange membranes and cation exchange membranes in the concentrate channels, the polarities of the electrodes of the EDR unit 11 were reversed every 1000 seconds. Thus, in the reversed polarity state, the dilute channels from the normal polarity state acted as the concentrate channels to receive the concentrate stream 17, and the concentrate channels from the normal polarity state functioned as the dilute channels to receive the feed stream 13. The streams 13 and 17 entered the EDR device 11 along respective second input pipes, as indicated by broken lines 39 and 40. The dilute stream 14 and the outflow stream 16 flowed along respective second output pipes, as indicated by broken lines 41 and 42.

The outside vessel 20 of the precipitation unit 12 comprises a cylindrical upper portion having a diameter of 250 mm and a height of 500 mm and a conic lower portion having a cone angle of 90 degrees. A total operating volume of the precipitation unit 12 is about 20 liters. Gypsum particles (200 g) were added as seed particles in the precipitation zone 28 in the precipitation element 21 and the confining element 22 before start up of the experiment and maintained in suspension by agitation of the agitation device 23 to enhance the precipitation in the precipitation unit 12.

The flow rates of both the feed stream 13 and the concentrate stream 17 were set as 0.5 liter per minute (lpm). There was precipitation happening in the precipitation unit 12. To maintain a stable quantity of seed particles in the precipitation unit 12, about 300 ml of slurry was discharged through a discharge stream 30 from the conic lower portion of the precipitation unit 12 in each cycle (2000 seconds) through a pump 25. The pump 25 helped a recirculation stream 43 back into the precipitation unit 12 or the discharge stream 30 for discharge of slurry. A valve 26 controlled the discharge stream 30 and the recirculation stream 43. At the same time, to keep a constant water volume in the precipitation unit 12, an overflow stream 29 was designed for overflowed water from the solid-liquid separation zone 24 of the precipitation unit 12 for safeguard. The discharge stream 30 and the overflow stream join 29 to form the stream 27. The flow rate of the pump 25 was about 6 litters per minute. A valve 204 was disposed on the lower portion of vessel 20 to facilitate evacuating the vessel 20.

In each cycle, there was about 400 ml of water discharged through the overflow stream 29. Therefore, a total volume of discharged water was about 700 ml per cycle while the total feed water volume was about 16.7 liters. The water recovery of the EDR unit 11 plus the precipitation unit 12 was then calculated to be about 95.8%. Table 2 shows major compositions of each stream into and out from the EDR unit 11 and the precipitation unit 12. Due to the addition of hydrochloric acid and its reaction with bicarbonate in the feed tank 50, the stream 13 has higher chloride concentration and lower bicarbonate concentration than the reject stream in Table 1.

TABLE 2

| | Composition (ppm wt/wt) | | | | | | | | |
|---|---|---|---|---|---|---|---|---|---|
| | Ca²⁺ | Mg²⁺ | Na⁺ | K⁺ | HCO₃⁻ | SO₄²⁻ | Cl⁻ | TDS | TSS |
| Stream 13 | 171 | 162 | 445 | 23 | ~0 | 843 | 861 | 2505 | 0 |
| Stream 14 | 13 | 14 | 66 | 2.6 | ~0 | 50 | 28 | 174 | 0 |
| Stream 17 | 760 | 2960 | 7649 | 414 | ~0 | 10851 | 19861 | 42495 | ~0 |
| Stream 16 | 874 | 2960 | 7649 | 414 | ~0 | 11092 | 19861 | 42850 | ~0 |
| Stream 27 | 760 | 2960 | 7649 | 414 | ~0 | 10851 | 19861 | 42495 | 13188 |

The result above also shows that the total dissolved solids (TDS) in the product stream 14 of the EDR unit 11 is in such a range that the product stream 14 can be sent back as a feed stream for an NF unit.

Take an industrial NF unit having a water recovery of about 85% for example and please refer back to FIG. 1, when a first stream of feed water 106 having a volumetric flow rate of 1296.4 lpm is transported through the first conduit 104 into the membrane desalination unit 102, a first stream of reject water 116 having a volumetric flow rate of 227.1 lpm and a higher salinity than the first feed stream of feed water 106 is transported from the membrane desalination unit 102 to the electrical separation unit 112 through the third conduit 114 connected with the membrane desalination unit (industrial NF unit) and the electrical separation unit 112. The fourth conduit 118 connects the electrical separation unit 112 and is configured to transport a second stream of product water 120 (having a volumetric flow rate of 217.6 lpm) of lower salinity than the first stream of reject water out from the electrical separation unit 112 to mix with the first stream of feed water 106. Thus, the volumetric flow rate of total feed stream to the membrane desalination unit 102 (NF unit) is 1514.0 lpm. With an 85% water recovery rate, the first stream of product water 110 of the membrane unit has a volumetric flow rate of 1286.9 lpm.

The fifth conduit 124 connects with the precipitation unit 122 and the electrical separation unit 112 and is configured to transport a second stream of reject water 126 of higher salinity than the first stream 116 of reject water from the electrical separation unit 112 to the precipitation unit 122. The sixth conduit 128 connected with the precipitation unit 122 and the electrical separation unit 112 is configured to transport a second stream of feed water 130 of lower salinity than the second stream of reject water 126 from the precipitation unit to the electrical separation unit. The seventh conduit 132 connected with the precipitation unit is configured to release a discharge stream of water 134. The above experimental result shows that the electrical separation unit 112 and the precipitation unit 122 has a water recovery rate of 95.8%, so the average volumetric flow rate of the discharge stream of water 134 is 9.5 lpm.

Thus, the overall device 100 (i.e., NF 102+EDR 112+precipitation unit 122) has a feed stream with a volumetric flow rate of 1296.4 lpm, a product stream with a volumetric flow rate of 1286.9 lpm and a waste stream with a volumetric flow rate of 9.5 lpm. Therefore, water recovery of the overall device 100 is 99.3%. Bicarbonates were effectively removed and there is no scaling in the device 100.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the spirit and scope of the disclosure as defined by the following claims.

What is claimed is:

1. A water treatment device, comprising:
a membrane desalination unit;
a first conduit connected with the membrane desalination unit and configured to transport a first stream of feed water to the membrane desalination unit;
a second conduit connected with the membrane desalination unit and configured to transport a first stream of product water of lower salinity than the first stream of feed water out of the membrane desalination unit;
an electrical separation unit;
a third conduit connected with the membrane desalination unit and the electrical separation unit and configured to transport a first stream of reject water of higher salinity than the first stream of feed water from the membrane desalination unit to the electrical separation unit;
a fourth conduit connected with the electrical separation unit and configured to transport a second stream of product water of lower salinity than the first stream of reject water out from the electrical separation unit;
a precipitation unit;
a fifth conduit connected with the precipitation unit and the electrical separation unit and configured to transport a second stream of reject water of higher salinity than the first stream of reject water from the electrical separation unit to the precipitation unit;
a sixth conduit connected with the precipitation unit and the electrical separation unit and configured to transport a second stream of feed water of lower salinity than the second stream of reject water from the precipitation unit to the electrical separation unit;
a seventh conduit connected with the precipitation unit and configured to release a discharge stream of water; and
a chemical injection unit in communication with at least one of the electrical separation unit and the precipitation unit.

2. The water treatment device according to claim 1, wherein the fourth conduit is connected with the first conduit and configured to transport the second stream of product water to mix with the first stream of feed water.

3. The water treatment device according to claim 1, wherein the membrane desalination unit comprises a nanofiltration membrane device or a reverse osmosis membrane device.

4. The water treatment device according to claim 1, wherein the electrical separation unit comprises an electrodialysis reversal desalination device or a supercapacitive desalination device.

5. The water treatment device according to claim 1, wherein the chemical injection unit comprises an acid injection unit comprising hydrochloric acid or sulfuric acid.

6. The water treatment device according to claim 1, wherein the chemical injection unit is in communication with at least one of the third conduit and the fifth conduit.

7. The water treatment device according to claim 1, further comprising a filtration device in communication with the sixth conduit.

8. A water treatment method comprising:
providing a membrane desalination unit;
providing a first conduit connected with the membrane desalination unit and configured to transport a first stream of feed water to the membrane desalination unit;
providing a second conduit connected with the membrane desalination unit and configured to transport a first stream of product water of lower salinity than the first stream of feed water out of the membrane desalination unit;
providing an electrical separation unit;
providing a third conduit connected with the membrane desalination unit and the electrical separation unit and configured to transport a first stream of reject water of higher salinity than the first stream of feed water from the membrane desalination unit to the electrical separation unit;
providing a fourth conduit connected with the electrical separation unit and configured to transport a second stream of product water of lower salinity than the first stream of reject water out from the electrical separation unit;
providing a precipitation unit;
providing a fifth conduit connected with the precipitation unit and the electrical separation unit and configured to transport a second stream of reject water of higher salinity than the first stream of reject water from the electrical separation unit to the precipitation unit;
providing a sixth conduit connected with the precipitation unit and the electrical separation unit and configured to transport a second stream of feed water of lower salinity than the second stream of reject water from the precipitation unit to the electrical separation unit;
providing a seventh conduit connected with the precipitation unit and configured to release a discharge stream of water; and
providing a chemical injection unit in communication with at least one of the electrical separation unit and the precipitation unit.

9. The water treatment method according to claim 8, wherein the membrane desalination unit comprises a nanofiltration membrane device or a reverse osmosis membrane device and wherein the electrical separation unit comprises an electrodialysis reversal desalination device or a supercapacitive desalination device.

10. The water treatment method according to claim 9, wherein the chemical injection unit comprises hydrochloric acid or sulfuric acid.
